(19) United States
(12) Patent Application Publication
(10) Pub. No.: US 2025/0378540 A1
(43) Pub. Date: Dec. 11, 2025

(54) METHOD FOR CORRECTING IMAGE

(71) Applicant: Shanghai United Imaging Healthcare Co., Ltd., Shanghai (CN)

(72) Inventors: Qiuhe Zhao, Shanghai (CN); Xiangbin Fang, Shanghai (CN); Can Liao, Shanghai (CN)

(21) Appl. No.: 19/228,916

(22) Filed: Jun. 5, 2025

(30) Foreign Application Priority Data
Jun. 5, 2024 (CN) 202410726663.5

(51) Int. Cl. G06T 5/80; G06T 5/50; G06T 5/60; G06T 7/11; G06T 7/73

(52) U.S. Cl. CPC G06T 5/80; G06T 5/50; G06T 5/60; G06T 7/11; G06T 7/73; G06T 2200/04; G06T 2207/10088; G06T 2207/20081; G06T 2207/30204

(57) ABSTRACT

A method for correcting an image is provided, which includes obtaining deformation information of pixels in the image based on first coordinates of the pixels through a deformation prediction model, where the deformation information includes target deformation information caused by gradient nonlinearity of a gradient magnetic field, determining second coordinates corresponding to the first coordinates based on the target deformation information and the first coordinates, and correcting the image based on pixel values corresponding to the second coordinates.

### CROSS-REFERENCE TO RELATED APPLICATIONS

The present disclosure claims priority to the Chinese patent application No. 202410726663.5, filed on Jun. 5, 2024, titled “Method for Correcting Image, Method for Training Deformation Prediction Model, and Storage Medium”, the content of which is hereby incorporated by reference in its entity.

### TECHNICAL FIELD

The present disclosure relates to the field of image processing, particularly to a method for correcting an image, a method for determining a deformation prediction model, and a storage medium.

### BACKGROUND

Images have a wide range of applications in the medical field, such as for the examination, diagnosis, and treatment of common diseases. However, during the imaging process, the reconstructed images may experience a certain degree of deformation, which necessitates the correction of this deformation. For example, magnetic resonance imaging (MRI) offers ultra-high soft tissue resolution and is widely used in applications such as simulation positioning and image-guided procedures. However, due to the influence of gradient nonlinearity of the gradient magnetic field, the reconstructed magnetic resonance (MR) images may experience deformation, and therefore, it is necessary to correct the deformation caused by gradient nonlinearity.

Currently, the deformation information is obtained using a field measurement tool that measures the gradient magnetic field on the spherical surface of a marker, obtaining measurement results. The results are then fitted using spherical harmonics to obtain the gradient magnetic field distribution in the imaging space. Based on the gradient magnetic field distribution, the deformation information of the image is calculated, and the image is corrected based on the deformation information.

However, the current use of field measurement tools to obtain deformation information has high requirements for the field measurement tools, and there are measurement errors and mechanical errors, which lead to inaccurate image correction.

### SUMMARY

One aspect of the present disclosure provides a method for correcting an image, which includes obtaining deformation information of pixels in the image based on first coordinates of the pixels through a deformation prediction model, where the deformation information includes target deformation information caused by gradient nonlinearity of a gradient magnetic field, determining second coordinates corresponding to the first coordinates based on the target deformation information and the first coordinates, and correcting the image based on pixel values corresponding to the second coordinates.

In some embodiments, the method further includes obtaining the deformation prediction model, wherein obtaining the deformation prediction model includes obtaining first sample coordinates of markers in a calibration phantom based on a sample image of the calibration phantom, registering the first sample coordinates of the markers with sample reference coordinates to determine second sample coordinates of the markers in an image coordinate system, determining sample deformation information of the markers based on the second sample coordinates and the first sample coordinates of the markers, and training an initial deformation prediction model using the sample reference coordinates and sample deformation information of the markers to obtain the deformation prediction model.

In some embodiments, obtaining the first sample coordinates of the markers in the calibration phantom based on the sample image of the calibration phantom includes segmenting geometries corresponding to the markers from the sample image based on preset sample coordinates of the markers, adjusting pixel values of pixels in each geometry that are smaller than a first preset pixel value to a second preset pixel value to obtain a first new geometry corresponding to the geometry, and obtaining the first sample coordinate of each marker based on pixel values of pixels in the first new geometry corresponding to the geometry.

In some embodiments, the sample image is a three-dimensional sample image, and segmenting the geometries corresponding to the markers from the sample image based on the preset sample coordinates of the markers includes determining a size of each marker based on a density of the marker, and segmenting the geometry corresponding to the marker from the sample image with a pixel of the preset sample coordinate as a center of the geometry.

In some embodiments, obtaining the first sample coordinate of each marker based on the pixel values of the pixels in the first new geometry corresponding to the geometry includes determining a third sample coordinate of the marker corresponding to the first new geometry based on the pixel values of the pixels in the first new geometry, and obtaining the first sample coordinate of the marker based on the third sample coordinate of the marker corresponding to the first new geometry and the preset sample coordinate.

In some embodiments, determining the third sample coordinate of the marker corresponding to the first new geometry based on the pixel values of the pixels in the first new geometry includes summing products of the pixel values of the pixels and corresponding coordinates in the first new geometry to obtain a first sum result, summing the pixel values of the pixels in the first new geometry to obtain a second sum result, and taking a ratio of the first sum result to the second sum result as the third sample coordinate of the marker.

In some embodiments, obtaining the first sample coordinate of the marker based on the third sample coordinate of the marker corresponding to the first new geometry and the preset sample coordinate includes taking the third sample coordinate of the marker as the first sample coordinate of the marker if a difference between the third sample coordinate of the marker and the preset sample coordinate is smaller than a preset difference.

In some embodiments, obtaining the first sample coordinate of the marker based on the third sample coordinate of the marker corresponding to the first new geometry and the preset sample coordinate includes segmenting a geometry corresponding to the marker from the sample image based on the third preset sample coordinate if a difference between the third sample coordinate of the marker and the preset sample coordinate is not smaller than a preset difference, adjusting pixel values of pixels in the geometry that are smaller than the first preset pixel value to the second preset pixel value to obtain a second new geometry, and obtaining the first sample coordinate of the marker based on pixel values of pixels in the second new geometry.

In some embodiments, the sample image includes a first sample image and a second sample image with opposite polarities, the sample deformation information includes a first set of sample deformation information corresponding to the first sample image and a second set of sample deformation information corresponding to the second sample image. Training the initial deformation prediction model using the sample reference coordinates and sample deformation information of the markers to obtain the deformation prediction model includes determining the target sample deformation information based on the first set of sample deformation information and the second set of sample deformation information, and training the initial deformation prediction model using the target sample deformation information and the sample reference coordinates of the markers to obtain the deformation prediction model.

In some embodiments, the image is a magnetic resonance image, and the method is applied to correct a distortion in the image associated with the gradient nonlinearity of the gradient magnetic field.

In some embodiments, correcting the image based on the pixel values corresponding to the second coordinates includes assigning the pixel values corresponding to the second coordinates to the corresponding first coordinates, or adjusting the pixel values corresponding to the second coordinates and assigning the adjusted pixel values to the corresponding first coordinates.

Another aspect of the disclosure provides a method for determining a deformation prediction model, which includes determining an initial deformation prediction model, obtaining first sample coordinates of markers in the calibration phantom from a sample image of the calibration phantom, registering the first sample coordinates of the markers and sample reference coordinates to determine second sample coordinates of the markers in an image coordinate system, determining sample deformation information of the markers based on the second sample coordinates of the markers and the first sample coordinates, and training the initial deformation prediction model using the sample reference coordinates of the markers and the sample deformation information to obtain the deformation prediction model.

Another aspect of the present disclosure provides a computer device, which includes a memory and a processor. The memory stores a computer program, and the processor, when executing the computer program, is configured to perform a method for correcting an image according to any one of the above-described embodiments.

The details of one or more embodiments of the present application are presented in the following drawings and descriptions. Other features, objectives, and advantages of the present application will become apparent from the description, drawings, and claims.

### BRIEF DESCRIPTION OF THE DRAWINGS

In order to more clearly explain the technical solutions in the embodiments of the present disclosure or related technologies, the following is a brief introduction to the drawings that are necessary for the embodiment or related technical descriptions. It is obvious that the drawings in the following description are merely some of the embodiments of the present disclosure. For those skilled in the art, without creative effort, it is possible to derive other drawings based on these.

FIG. 1 is an application environment diagram of a method for correcting an image in an embodiment.

FIG. 2 is a schematic flowchart of a method for correcting an image in an embodiment.

FIG. 3 is a schematic diagram of a deformation prediction model in an embodiment.

FIG. 4 is a schematic diagram of image correction based on deformation information in an embodiment.

FIG. 5 is a schematic flowchart of a method for determining a deformation prediction model in an embodiment.

FIG. 6 is a schematic flowchart of a first sample coordinate obtaining method in an embodiment.

FIG. 7 is a schematic flowchart of a first sample coordinate obtaining method in another embodiment.

FIG. 8 is a schematic flowchart of a first sample coordinate obtaining method in another embodiment.

FIG. 9 is a schematic flowchart of a method for correcting an image in another embodiment.

FIG. 10 is a schematic flowchart of a method for determining a deformation prediction model in another embodiment.

FIG. 11 is a block diagram of a structure of an image correction apparatus in an embodiment.

FIG. 12 shows an internal structure of a computer device in an embodiment.

### DETAILED DESCRIPTION

In order to make the objectives, technical solutions, and advantages of the present disclosure clearer, the following is a more detailed description of the application with reference to the accompanying drawings and embodiments. It should be understood that the specific embodiments described here are merely for the purpose of explaining the present disclosure and are not intended to limit the scope of the application.

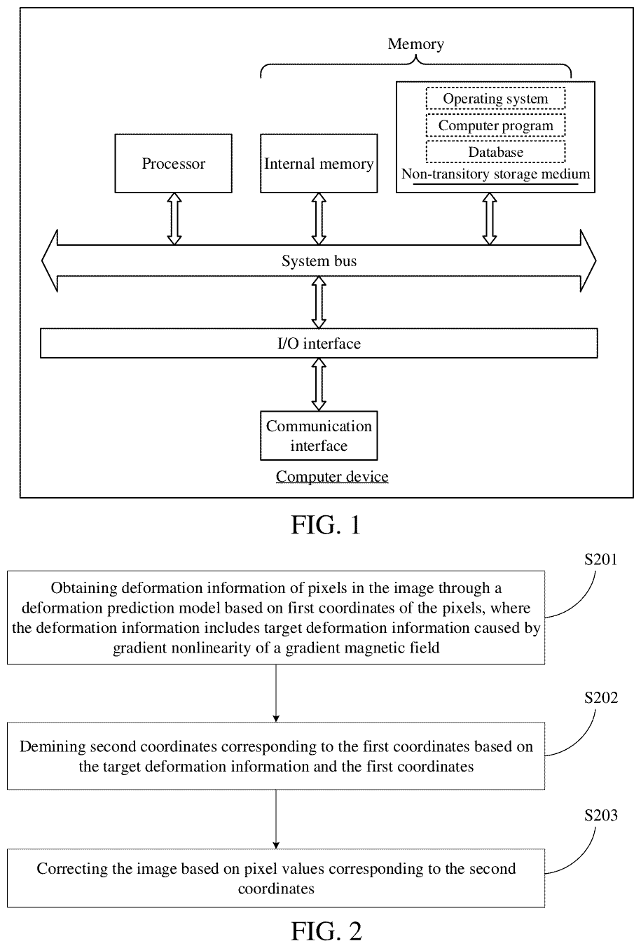

In embodiments of the present disclosure, methods for correcting an image are provided, which can be applied in the application environment shown in FIG. 1. The application environment includes a computer device, which may be a server, and the internal structure of the computer device is shown in FIG. 1. The computer device includes a processor, a memory, an input/output (I/O) interface, and a communication interface. The processor, memory, and input/output interface are connected via a system bus, and the communication interface is connected to the system bus via the input/output interface. The processor of the computer device is configured to provide computational and control capabilities. The memory of the computer device includes non-transitory storage medium and internal memory. The non-transitory storage medium stores an operating system, computer programs, and databases. The internal memory provides an environment for the operation of the operating system and computer programs stored in the non-transitory storage medium. The database of the computer device is configured to store data for image correction. The input/output interface of the computer device is configured to exchange information between the processor and external devices. The communication interface of the computer device is configured to communicate with external terminals via a network. The computer program is executed by the processor to implement the methods for correcting an image. The server can be implemented using a single server or a server cluster composed of multiple servers.

In an exemplary embodiment, as shown in FIG. 2, a method for correcting an image is provided. With reference to the example where the method is applied in a computer device in FIG. 1, the method includes steps S201 to S203.

In the step S201, deformation information of pixels in the image is obtained through a deformation prediction model based on first coordinates of the pixels. The deformation information includes target deformation information caused by gradient nonlinearity of a gradient magnetic field.

The image may be a magnetic resonance (MR) image.

As a non-limiting example, the image is an MR image acquired within an imaging space of a scanning device. The deformation prediction model may be a machine learning model, such as a convolutional neural network or a deep belief network, or a model obtained by adjusting an existing artificial intelligence (AI) model, or the like.

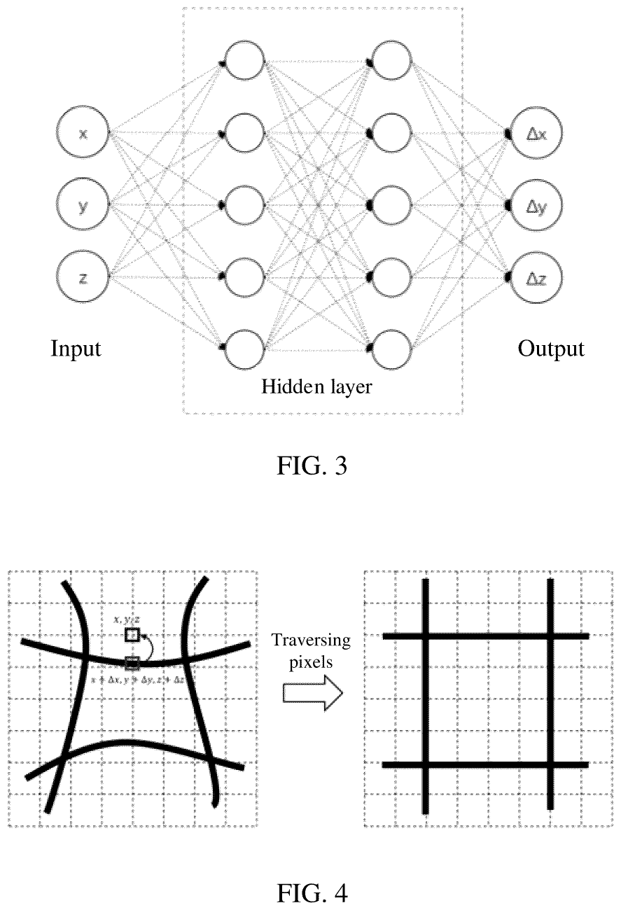

In some embodiments, by using the scanning device to acquire an image of an object, the first coordinates of all or part of the pixels in the image are sequentially input to the deformation prediction model to obtain the target deformation information of the pixels. FIG. 3 is a schematic diagram of the deformation prediction model in an embodiment. Exemplarily, the first coordinate could be in the form of (x, y, z), and by inputting the first coordinate (x, y, z) into the deformation prediction model, the target deformation information (Δx, Δy, Δz) is output. The target deformation information may take various forms, which are not limited here. As a non-limiting example, the target deformation information may include displacement deviations of the pixel coordinates after deformation, or deformation coefficients of the pixel coordinates after deformation, and so on.

In some embodiments, the deformation prediction model directly outputs deformation information caused by the gradient nonlinearity of the gradient magnetic field, i.e., the target deformation information.

In some embodiments, the deformation prediction model outputs deformation information caused by both the gradient nonlinearity of the gradient magnetic field and the inhomogeneity of a main magnetic field. This deformation information is further processed, for example, by inputting it into an independent model to remove the deformation information caused by the inhomogeneity of the main magnetic field, thereby obtaining the target deformation information. In a possible implementation, the first coordinates of all or part of the pixels in the image can be sequentially input into the deformation prediction model to obtain the deformation information of the pixels, and the deformation information includes deformation caused by the gradient nonlinearity of the gradient magnetic field, or deformation caused by both the gradient nonlinearity of the gradient magnetic field and the inhomogeneity of the main magnetic field.

In a possible implementation, prior knowledge can be used to determine a deformation area from the image, and the first coordinates of the pixels in the deformation area are input into the deformation prediction model to output the deformation information or the target deformation information of the pixels.

In the step S202, second coordinates corresponding to the first coordinates are determined based on the target deformation information and the first coordinates.

In some embodiments, the target deformation information and the first coordinates can be combined to obtain post-deformation coordinates corresponding to the first coordinates in the image, i.e., the second coordinates corresponding to the first coordinates. For example, when the target deformation information represents the displacement deviations of the pixels, the target deformation information can be added to the first coordinates to obtain the second coordinates. For instance, as shown in FIG. 4, the first coordinate (x, y, z) and the target deformation information (or the target deformation information multiplied by a predetermined coefficient) can be added to obtain the corresponding second coordinate. As another example, when the target deformation information represents the deformation coefficients of the pixels, the target deformation information can be multiplied by the first coordinate to obtain the corresponding second coordinate.

It can be understood that determining the second coordinates corresponding to the first coordinate based on the target deformation information and the first coordinates can be directly implemented in the deformation prediction model in some embodiments, i.e., the second coordinates are directly output by the deformation prediction model.

In the step S203, the image is corrected based on pixel values corresponding to the second coordinates.

In some embodiments, the pixel values corresponding to the second coordinates can be assigned to the corresponding first coordinates to complete the image correction. The correction method is configured to correct the distortion in the image associated with the gradient nonlinearity.

As another example, the pixel values corresponding to the second coordinates can also be adjusted, and the adjusted pixel values are assigned to the corresponding first coordinates to complete the image correction. For example, different weights can be assigned to the pixel values corresponding to the second coordinates, and the weights are multiplied by the corresponding pixel values to obtain adjusted pixel values.

As another example, part of the pixel values of multiple second coordinates can be adjusted, while the pixel values of the rest second coordinates remain unadjusted. The adjusted pixel values and the unadjusted pixel values are then assigned to the corresponding first coordinates to complete the image correction.

In the above method for correcting an image, the deformation information of the pixels is obtained by the deformation prediction model based on the first coordinates of the pixels in the image, and the obtained deformation information includes deformation information caused by the nonlinear gradient. Based on the deformation information and the first coordinates, the second coordinates corresponding to the first coordinates are determined. The image is then corrected based on the pixel values corresponding to the second coordinates. In this embodiment, the deformation prediction model is configured to predict the deformation of the pixels in the image to obtain the target deformation information, which allows for determining the post-deformation second coordinates corresponding to the first coordinates in the image based on the target deformation information. The image is then corrected based on the pixel values corresponding to the second coordinates, without the need to use measurement tools to measure the gradient magnetic field on a spherical surface, thus avoiding measurement and mechanical errors inherent in the use of such tools, which improves the accuracy of image correction.

In some embodiments, before obtaining the deformation information of the pixels based on the first coordinates through the deformation prediction model, the method further includes determining the deformation prediction model.

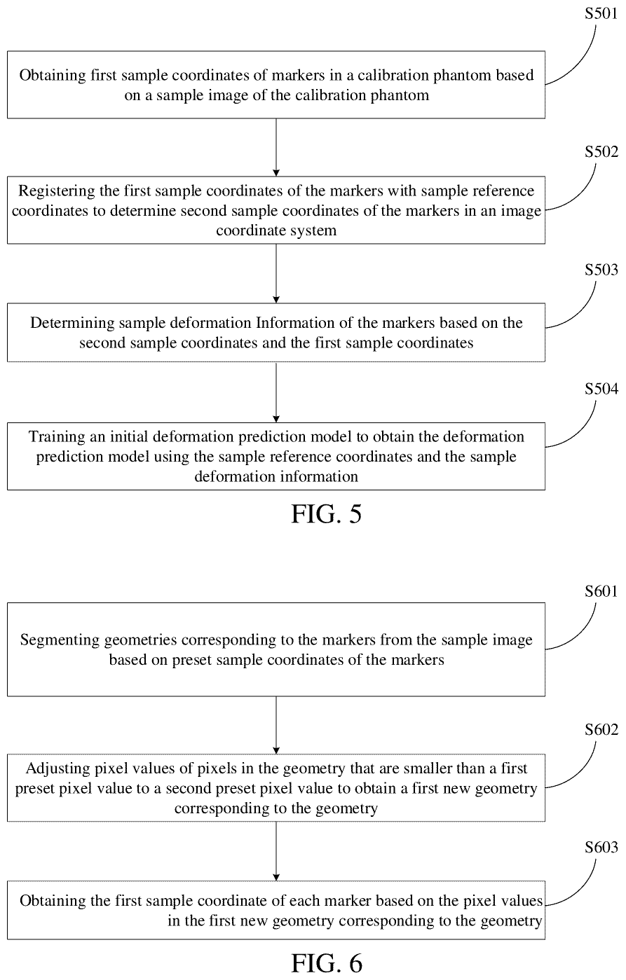

FIG. 5 is a flowchart of a method for determining a deformation prediction model in an embodiment. As shown in FIG. 5, the method includes the following steps S501-S504.

In the step S501, first sample coordinates of markers in a calibration phantom are obtained based on a sample image of the calibration phantom.

As an example, markers in the calibration phantom can be evenly distributed or distributed at specific locations, and the markers are able to generate magnetic field signals. The markers can take any suitable shape, such as a sphere, a point, a cube, a cylinder, an octahedron, a dodecahedron, and so on. The size of the calibration phantom can cover the entire or part of the imaging space of a magnetic resonance apparatus. As a non-limiting example, the calibration phantom may contain 2700 spheres with a diameter of 10 mm, with a center-to-center spacing of 20 mm, and the spheres are filled with liquid (e.g., water, saline solution).

It can be understood that the calibration phantom used to determine the deformation prediction model can be different from the detected object corresponding to the image in the image correction method of the present disclosure. That is, it is not necessary to use the actual to-be-detected object to collect sample deformation information for model training. Instead, calibration phantoms with the above-mentioned characteristics are adopted to obtain the actual image deformation caused by gradient nonlinearity.

In this embodiment, the center of the calibration phantom can be placed at the isocenter of the scanning device, and the calibration phantom is scanned to obtain a sample image of the calibration phantom. The markers in the calibration phantom can be sliced, and central layer images of the markers can be thus obtained. Based on the coordinates of the central layer images, the first sample coordinates of the markers can be determined.

In a possible implementation, preset sample coordinates of the markers can first be determined, and based on the preset coordinates, geometries corresponding to the markers can be segmented from the sample image. Based on pixel values of pixels in the geometries corresponding to the markers, the first sample coordinates of the markers can be determined. The geometries corresponding to the markers may surround or enclose the markers.

In the step S502, the first sample coordinates of the markers are registered with sample reference coordinates to determine second sample coordinates of the markers in an image coordinate system.

The sample reference coordinates can be obtained from drawings of the calibration phantom or by scanning the calibration phantom to obtain a computed tomography (CT) image, etc., from which the sample reference coordinates can be derived. The sample reference coordinate can be either a theoretical coordinate or an accurate actual coordinate obtained by other detection methods, such as CT scans or X-ray imaging.

In some embodiments, the image coordinate system refers to the coordinate system of a reference sample image corresponding to the sample reference coordinates. When calculating the sample deformation information, it is necessary to know the actual sample coordinates of the markers in the image coordinate system. Registration algorithms can be directly applied to register the first sample coordinates of the markers and the sample reference coordinates, determining the second sample coordinates of the markers in the image coordinate system, i.e., the actual sample coordinates of the markers in the image coordinate system. Optional registration algorithms include Iterative Closest Point (ICP), Robust Point Matching (RPM), Kernel Correlation (KC), and Coherent Point Drift (CPD), etc.

In some embodiments, the first sample coordinates and the sample reference coordinates are in different coordinate systems (e.g., taken from MR images and CT images, respectively). Therefore, the sample reference coordinates need to be mapped to the coordinate system of the first sample coordinates, i.e., the registration of the two coordinate systems.

In a possible implementation, among the pixels in the sample image, the deformation of pixels that are imaged at the isocenter of the scanning device is minimal. To reduce registration errors, the first sample coordinates can be within a certain range of the pixel located at the isocenter of the image. For example, the first sample coordinates can be selected within a certain diameter range from the isocenter in the sample image. As a non-limiting example, first sample coordinates can be within a 100 mm diameter of spherical volume (DSV), or within a 400 mm DSV (in which image deformation is, for example, less than 0.5 mm). Registration algorithms can be used to register the first sample coordinates and the sample reference coordinates to obtain the second sample coordinates of the markers in the image coordinate system.

In the step S503, sample deformation information of the markers is determined based on the second sample coordinates and the first sample coordinates.

In some embodiments, the difference between the second sample coordinate and the first sample coordinate can be used as the sample deformation information of the marker.

In a possible implementation, the difference can also be adjusted (for example, by multiplying by a preset weight coefficient, or adding or subtracting a preset calibration value) to obtain the sample deformation information of the marker.

In the step S504, an initial deformation prediction model is trained to obtain the deformation prediction model using the sample reference coordinates and the sample deformation information.

In this embodiment, the sample reference coordinates and the sample deformation information are input into the initial deformation prediction model. The initial deformation prediction model, based on the sample reference coordinates, generates predicted sample deformation information corresponding to the sample reference coordinates. The parameters of the initial deformation prediction model are adjusted based on the sample deformation information and the predicted sample deformation information, thus obtaining the deformation prediction model. As an example, the input of the obtained deformation prediction model can be the coordinates of pixels in the image, and the output can be the corresponding deformation information of the input coordinates. The deformation information includes the deformation caused by the gradient nonlinearity of the gradient magnetic field and the deformation caused by the inhomogeneity of the main magnetic field.

In a possible implementation, sample images include a first sample image and a second sample image with opposite gradient polarities (for example, two sample images with opposite gradient readings), and the sample deformation information may include a first set of sample deformation information corresponding to the first sample image and a second set of sample deformation information corresponding to the second sample image. Based on the first set of sample deformation information and the second set of sample deformation information, the target sample deformation information caused by the gradient nonlinearity can be determined. Using the target sample deformation information and the sample reference coordinates of the markers, the initial deformation prediction model can be trained to obtain the deformation prediction model. As an example, the input of the obtained deformation prediction model can be the coordinates of pixels in the image, and the output can be the corresponding deformation information of the input coordinates caused by the gradient nonlinearity. For example, two MR images generated based on opposite gradient polarities are used to obtain two sets of sample deformation information. The two sets of sample deformation information are weighted and averaged to obtain the target sample deformation information, which is then used for the training of the deformation prediction model.

In an alternative implementation, two sets of sample deformation information are obtained based on two MR images with opposite gradient polarities. Independent training is conducted based on the two sets of sample deformation information to generate two distortion correction models. The two distortion correction models are then input into a new neural network (such as DNN, GNN, CNN, MLP, or other neural network structures) to realize the final neural network output of distortion compensation, thereby forming the deformation prediction model.

In some embodiments, the initial deformation prediction model can be a holistic, end-to-end network model, such as a convolutional neural network, deep belief network, or other machine learning models. The initial deformation prediction model can also be a model obtained by integrating various algorithms or a model that includes various sub-models, such as a model obtained by combining principal component analysis and convolutional neural networks.

In some embodiments, based on the sample image of the calibration phantom, the first sample coordinates of the markers in the calibration phantom are obtained. The first sample coordinates and the sample reference coordinates are registered to determine the second sample coordinates in the image coordinate system. Based on the second sample coordinates and first sample coordinates of the markers, the sample deformation information of the markers is determined. Using the sample reference coordinates and the sample deformation information of the markers, the initial deformation prediction model is trained to obtain the deformation prediction model. In the embodiments, the deformation prediction model is obtained from the first sample coordinates of the markers in the sample image, which serves as the basis for subsequently obtaining the deformation information of the coordinates in the image through the deformation prediction model.

In some embodiments, calibration phantoms with different characteristics are used to obtain different training data, i.e., sample reference coordinates and sample deformation information. It follows that the initial model can be trained based on the training data corresponding to the different calibration phantoms to obtain the deformation prediction model.

The trained deformation prediction model can be configured to obtain and output the deformation information corresponding to first coordinates of pixels of an image. Alternatively, the trained deformation prediction model can be configured to obtain the deformation information corresponding to the first coordinates of the pixels and directly output second coordinates which are determined based on the first coordinates and the deformation information.

FIG. 6 is a flowchart of a method for obtaining the first sample coordinates in an embodiment. As shown in FIG. 6, this embodiment involves a possible implementation of how to obtain the first sample coordinates of the markers in the calibration phantom based on the sample image of the calibration phantom, which includes the following steps S601-S603.

In the step S601, geometries corresponding to the markers are segmented from the sample image based on preset sample coordinates of the markers.

In this embodiment, the size (e.g., radius, volume) of each marker is determined according to the density of the marker. The sample image is a 3D sample image. The geometries corresponding to the markers are segmented from the sample image, taking the pixel of the preset sample coordinate of each marker as the center of each geometry.

In the step S602, pixel values of pixels in the geometry that are smaller than a first preset pixel value are adjusted to a second preset pixel value to obtain a first new geometry corresponding to the geometry.

Optionally, the first preset pixel value is greater than the second preset pixel value, and the second preset pixel value may be 0.

In this embodiment, in the geometry corresponding to the marker, the pixels with pixel values smaller than the first preset pixel value are identified, and the pixel values of these pixels are set to the second preset pixel value. For example, if the first preset pixel value is 100 and the second preset pixel value is 0, the pixel values of the pixels in the geometry smaller than 100 are set to 0, so as to form the first new geometry.

In step S603, the first sample coordinate of each marker is obtained based on the pixel values in the first new geometry corresponding to the geometry.

In some embodiments, a third sample coordinate of the marker can be obtained based on the pixel values and corresponding coordinates in the first new geometry. The first sample coordinate of the marker is then obtained based on the difference between the third sample coordinate and the preset sample coordinate.

In a possible implementation, a preset number of pixels can be evenly selected from the first new geometry corresponding to the geometry. The third sample coordinate of the marker can then be obtained based on the pixel values of the selected preset number of pixels. The first sample coordinate of the marker is then obtained based on the difference between the third sample coordinate and the preset sample coordinate.

In some embodiments, based on the preset sample coordinate of the marker, the geometry corresponding to the marker is segmented from the sample image. The pixel values of the pixels in the geometry that are smaller than the first preset pixel value are adjusted to the second preset pixel value, thus forming the first new geometry corresponding to the geometry. The first sample coordinate of the marker is then obtained based on the pixel values of the pixels in the first new geometry. In some embodiments, the first sample coordinates of the markers are determined from the sample image, which serves as the basis for subsequent steps including determining the second sample coordinates based on the first sample coordinates and the sample reference coordinates, determining the sample deformation information based on the second sample coordinates and the first sample coordinates, and determining the deformation prediction model based on the sample deformation information. This approach facilitates the direct obtaining of the deformation information based on first coordinates of pixels through the deformation prediction model in future applications, eliminating the need for conventional field measurement tools to obtain deformation information, thereby improving the accuracy of obtaining the deformation information.

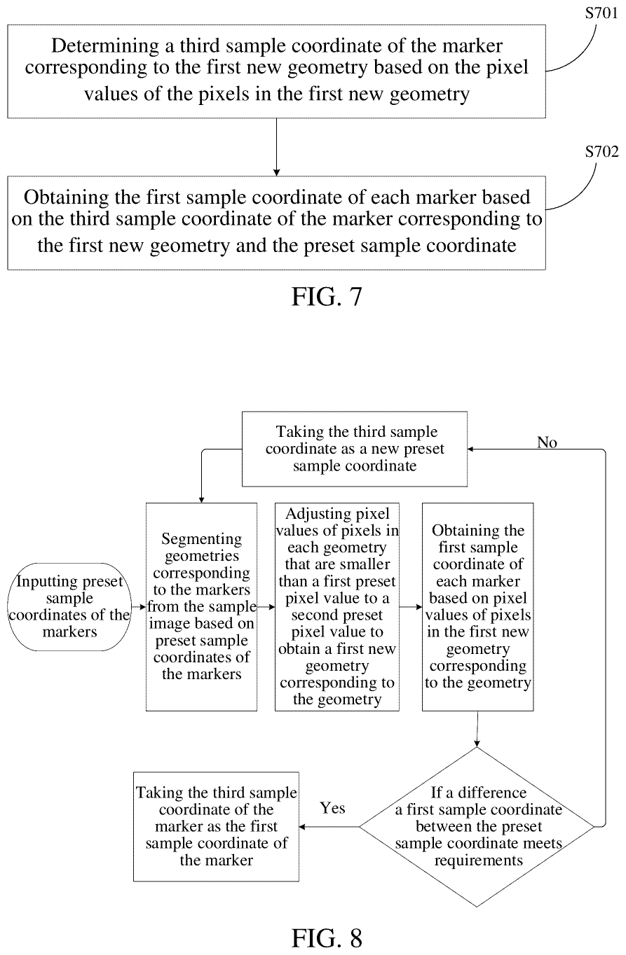

FIG. 7 is a flowchart of a method of obtaining the first sample coordinate in another embodiment. As illustrated in FIG. 7, this embodiment relates to how to obtain the first sample coordinate of each marker based on the pixel values of the pixels in the first new geometry corresponding to the geometry, which includes the following steps S701 and S702.

In the step S701, a third sample coordinate of the marker corresponding to the first new geometry is determined based on the pixel values of the pixels in the first new geometry.

As a non-limiting embodiment, for the first new geometry corresponding to the geometry, the products of the pixel values and their corresponding coordinates are summed to obtain a first sum result. In addition, the pixel values are summed to obtain a second sum result. The ratio of the first sum result to the second sum result is then taken as the third sample coordinate of the marker corresponding to the first new geometry. For example, in the first new geometry, assuming that the coordinate of the pixel value in the X direction is xi and the pixel value corresponding to the coordinate xi is pi, the first sum result can be obtained by multiplying the coordinate xi by the pixel value pi and summing the multiplication results. The pixel values pi are summed to obtain the second sum result. The ratio of the first sum result to the second sum result is taken as the coordinate of the third sample coordinate in the X direction.

In the step S702, the first sample coordinate of each marker is obtained based on the third sample coordinate of the marker corresponding to the first new geometry and the preset sample coordinate.

In this embodiment, the difference between the third sample coordinate of the marker corresponding to the first new geometry and the preset sample coordinate is obtained, and the first sample coordinate of the marker is then obtained based on the difference and a preset difference.

Further, obtaining the first sample coordinate of the marker based on the third sample coordinate of the marker corresponding to the first new geometry and the preset sample coordinate includes the following two cases.

The first case is that if the difference between the third sample coordinate of the marker and the preset sample coordinate is smaller than the preset difference, the third sample coordinate of the marker is taken as the first sample coordinate of the marker.

The second case is that if the difference between the third sample coordinate of the marker and the preset sample coordinate is not smaller than the preset difference, the third sample coordinate is taken as a new preset sample coordinate, and the process returns to segment a new geometry corresponding to the marker from the sample image based on the new preset sample coordinate, and adjust the pixel values of the pixels in the new geometry that are smaller than the first preset pixel value to the second preset pixel value to obtain a second new geometry corresponding to the new geometry. The above steps are iterated until the difference between the third sample coordinate of the marker corresponding to a currently obtained second new geometry and the new preset sample coordinate is smaller than the preset difference. At this point, the third sample coordinate of the marker corresponding to the currently obtained second new geometry is taken as the first sample coordinate of the marker.

In some embodiments, as shown in FIG. 8, when the difference between the third sample coordinate of the marker and the preset sample coordinate is smaller than the preset difference, the third sample coordinate of the marker is taken as the first sample coordinate of the marker.

If the difference between the third sample coordinate of the marker and the preset sample coordinate is not smaller than the preset difference, the third sample coordinate is used to update the preset sample coordinate, obtaining a new preset sample coordinate. Based on the new preset sample coordinate, the new geometry corresponding to the marker is segmented from the sample image. The pixel values of the pixels in the new geometry that are smaller than the first preset pixel value are adjusted to the second preset pixel value, so as to form a second new geometry corresponding to the new geometry. Based on the pixel values of the pixels in the second new geometry, a new third sample coordinate (i.e., the third sample coordinate of the marker corresponding to the second new geometry) is determined. The above steps are iterated until the difference between the new third sample coordinate and the new preset sample coordinate is smaller than the preset difference, and at this point, the new third sample coordinate is taken as the first sample coordinate.

Taking the marker as a sphere, the geometry as a cube, and the second preset pixel value as 0 as an example, an expected position of the sphere (i.e., preset sample coordinate) is input, and a cube is segmented with the voxel at the expected position of the sphere as the center. The gray values (i.e., pixel values) of the voxels in the cube that are smaller than the preset gray value (i.e., first preset pixel value) are set to zero, forming a first new cube. The density-weighted center (i.e., third sample coordinate) is calculated based on the gray values of the voxels in the first new cube. It is then determined whether the density-weighted center lies on the center voxel (i.e., preset sample coordinate) of the first new cube. If yes, the density-weighted center is output as the coordinate of the sphere. If not, the expected position is updated to the density-weighted center, and the above steps are iterated until the density-weighted center meets the requirement.

In some embodiments, the third sample coordinate of the marker corresponding to the first new geometry is determined based on the pixel values of the pixels in the first new geometry. The first sample coordinate of the marker is obtained based on the third sample coordinate of the marker and the preset sample coordinate. In the embodiments, through multiple iterations, the first sample coordinate of the marker is obtained, with a detection precision of up to 0.2 pixel, achieving sub-pixel level marker position detection, and the accuracy of the determination of the deformation prediction model based on the first sample coordinate is thus improved, resulting in better image correction effects.

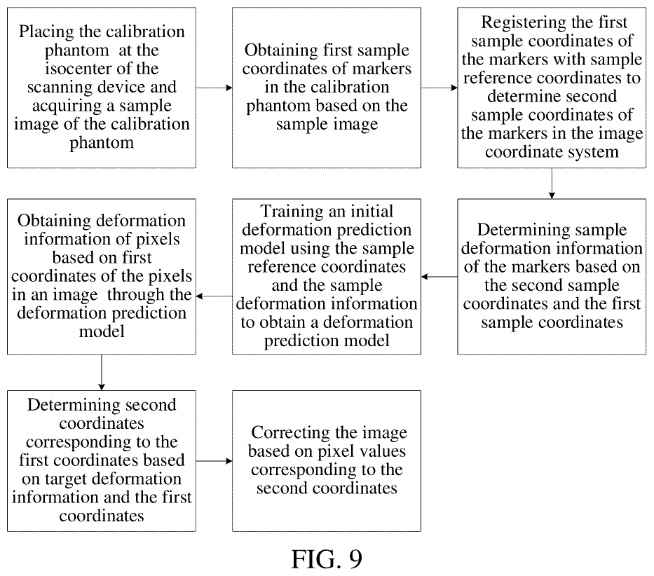

FIG. 9 is a flowchart of a method for correcting an image in another embodiment. In the method as shown in FIG. 9, a calibration phantom is placed at the isocenter of the scanning device, and a sample image of the calibration phantom is acquired through the scanning device. First sample coordinates of markers in the calibration phantom are obtained based on the sample image. Registration is then performed between the first sample coordinates of the markers and sample reference coordinates to determine second sample coordinates of the markers in the image coordinate system. Based on the second sample coordinates and the first sample coordinates, sample deformation information of the markers is determined, and an initial deformation prediction model is trained using the sample reference coordinates of the markers and the sample deformation information to obtain a deformation prediction model. Based on first coordinates of pixels in an image, deformation information of the pixels is obtained through the deformation prediction model. Based on target deformation information of the pixels and the first coordinates, second coordinates corresponding to the first coordinates are determined, and the image is corrected based on the pixel values corresponding to the second coordinates.

For example, with an MRI device as the scanning device, the calibration phantom is placed at the isocenter of the MRI device, and an MR image (i.e., sample image) of the calibration phantom is acquired. Positions of markers in the MR image (i.e., first sample coordinates) are then identified, and the positions of the markers are registered with theoretical coordinates of the markers (i.e., sample reference coordinates) to obtain position deviations of the markers (i.e., sample deformation information). A neural network model (i.e., initial deformation prediction model) is then trained using the position deviations. Deformation of the entire space (i.e., deformation information) is predicted through the trained neural network model, and the image is corrected based on the deformation.

In some embodiments, the first sample coordinates of the markers in the calibration phantom are obtained based on the sample image, and the sample deformation information is obtained based on the first sample coordinates. The deformation prediction model is obtained by training the initial deformation prediction model using the sample deformation information and the sample reference coordinates, and is then configured to predict the deformation of pixels in an image to obtain deformation information. The image is then corrected based on target deformation information from the deformation information. This method omits the need to measure the gradient magnetic field on a spherical surface using a measurement tool, thus avoiding the possibility of measurement errors that occur with the use of measurement tools and improving the accuracy of image correction.

In an embodiment, sample images include a first sample image and a second sample image with opposite polarities. The sample deformation information includes a first set of sample deformation information corresponding to the first sample image and a second set of sample deformation information corresponding to the second sample image. Training the initial deformation prediction model using the sample reference coordinates of the markers and the sample deformation information to obtain the deformation prediction model includes determining the target sample deformation information based on the first set of sample deformation information and the second set of sample deformation information and training the initial deformation prediction model using the target sample deformation information and the sample reference coordinates of the markers to obtain the deformation prediction model.

In this embodiment, the sample deformation information includes the first set of sample deformation information corresponding to the first sample image and the second set of sample deformation information corresponding to the second sample image. An average sample deformation information of the first set of sample deformation information and the second set of sample deformation information is obtained, and this average sample deformation information is used as the target sample deformation information. The target sample deformation information reflects the impact caused by the gradient nonlinearity only.

The target sample deformation information and the sample reference coordinate are input into the initial deformation prediction model. Based on the sample reference coordinates, the initial deformation prediction model generates the predicted target sample deformation information corresponding to the sample reference coordinates. The parameters of the initial deformation prediction model are adjusted based on the target sample deformation information and the predicted target sample deformation information, thereby obtaining the deformation prediction model.

In the embodiments, the target sample deformation information is determined based on the first set of sample deformation information and the second set of sample deformation information, and the initial deformation prediction model is trained using the target sample deformation information. Since the target sample deformation information only reflects the impact caused by the gradient nonlinearity, the deformation prediction model trained using the target sample deformation information can directly predict the deformation information caused by the gradient nonlinearity based on the first coordinates, thereby improving the efficiency of image correction.

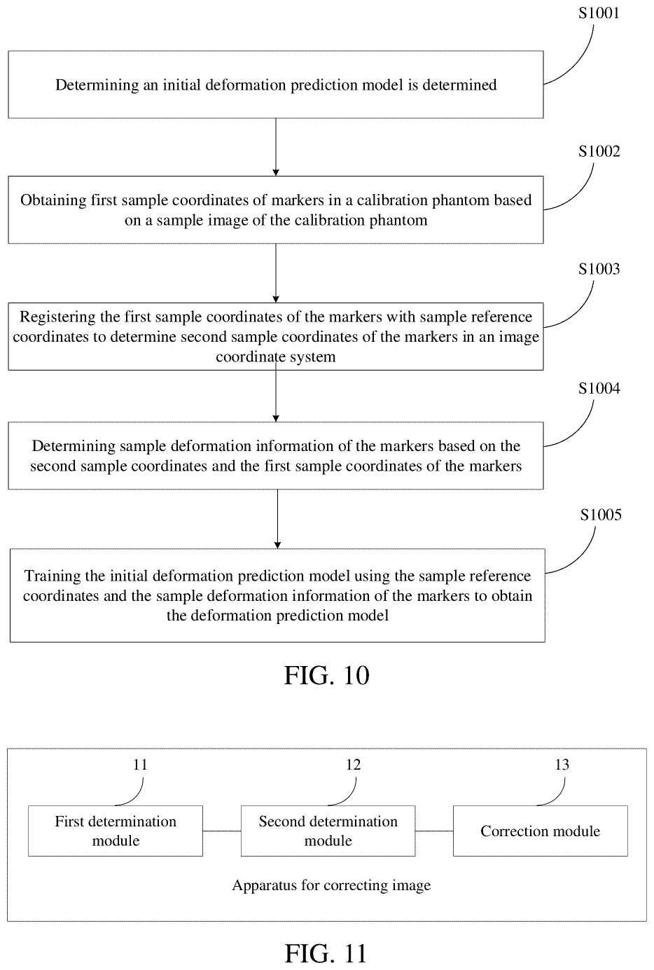

FIG. 10 is a flowchart of a method for determining the deformation prediction model in another embodiment. As shown in FIG. 10, the method includes the following steps S1001 to S1005.

In the step S1001, an initial deformation prediction model is determined.

In some embodiments, any neural network model can be selected as the initial deformation prediction model. Alternatively, a model that has been pre-trained can be used as the initial deformation prediction model, and by simply fine-tuning the pre-trained model, the deformation prediction model can be obtained.

In the step S1002, first sample coordinates of markers in a calibration phantom are obtained based on a sample image of the calibration phantom.

The specific implementation can be understood with reference to the above-described step S501.

In the step S1003, the first sample coordinates of the markers are registered with sample reference coordinates to determine second sample coordinates of the markers in an image coordinate system.

The specific implementation can be understood with reference to the above-described step S502.

In the step S1004, sample deformation information of the markers is determined based on the second sample coordinates and the first sample coordinates of the markers.

The specific implementation can be understood with reference to the above-described step S503.

In the step S1005, the initial deformation prediction model is trained using the sample reference coordinates and the sample deformation information of the markers to obtain the deformation prediction model.

The specific implementation can be understood with reference to the above-described step S504.

In the embodiments, the initial deformation prediction model is determined. Based on the sample image of the calibration phantom, the first sample coordinates of the markers in the calibration phantom are obtained. The first sample coordinates of the markers and the sample reference coordinates are registered to determine the second sample coordinates of the markers in the image coordinate system. Based on the second sample coordinates and the first sample coordinates of the markers, the sample deformation information of the markers is obtained. Using the sample reference coordinates and the sample deformation information of the markers, the initial deformation prediction model is trained to obtain the deformation prediction model. In the embodiments, the deformation prediction model is obtained based on the first sample coordinates of the markers in the sample image of the calibration phantom, which serves as the basis for subsequently obtaining deformation information of coordinates in an image through the deformation prediction model.

It should be understood that although the steps in the flowchart of the embodiments above are shown sequentially as indicated by the arrows, these steps do not necessarily have to be performed in the order indicated by the arrows. Unless explicitly stated in this document, there is no strict order requirement for these steps, and these steps can be performed in another order. Furthermore, at least part of the steps in the flowchart in the above embodiments can include multiple steps or stages, which do not necessarily need to be completed at the same time but can be performed at different times. The performing order of these steps or stages does not have to be sequential and can be performed in parallel or alternately with other steps or stages.

Based on the same concept, the embodiments of the present disclosure also provide an apparatus for correcting an image, which implements the method described above. The solution provided by the apparatus to solve the problem is similar to the solution described in the method above, so the specific limitations of one or more embodiments of the apparatus for correcting the image can be understood with reference to the description of the method for correcting an image above, and will not be repeated here.

In an exemplary embodiment, as shown in FIG. 11, an apparatus for correcting an image is provided, which includes a first determination module 11, a second determination module 12, and a correction module 13.

The first determination module 11 is configured to obtain deformation information of pixels in the image based on first coordinates of the pixels through a deformation prediction model, where the deformation information includes target deformation information caused by the gradient nonlinearity of a gradient magnetic field.

The second determination module 12 is configured to determine second coordinates corresponding to the first coordinates based on the target deformation information and the first coordinates.

The correction module 13 is configured to correct the image based on pixel values corresponding to the second coordinates.

In an embodiment, the image correction apparatus further includes an obtaining module, a registration module, a third determination module, and a training module.

The obtaining module is configured to obtain first sample coordinates of markers in the calibration phantom based on the sample image of the calibration phantom.

The registration module is configured to register the first sample coordinates of the markers and sample reference coordinates, and to determine second sample coordinates of the markers in the image coordinate system.

The third determination module is configured to determine sample deformation information of the markers based on the second sample coordinates and the first sample coordinates.

The training module is configured to train an initial deformation prediction model using the sample reference coordinates and the sample deformation information to obtain the deformation prediction model.

In an embodiment, the obtaining module includes a segmentation unit, an adjustment unit, and an obtaining unit.

The segmentation unit is configured to segment geometries corresponding to the markers from the sample image based on the preset sample coordinates of the markers.

The adjustment unit is configured to adjust pixel values of pixels in each geometry that are smaller than a first preset pixel value to a second preset pixel value to obtain a first new geometry corresponding to the geometry.

The obtaining unit is configured to obtain a first sample coordinate of each marker based on pixel values of pixels in the first new geometry corresponding to the geometry.

In an embodiment, the obtaining unit is further configured to determine a third sample coordinate of each marker corresponding to the first new geometry based on the pixel values of the pixels in the first new geometry, and based on the third sample coordinate of the marker corresponding to the first new geometry and the preset sample coordinate, obtain the first sample coordinate of the marker.

In an embodiment, the obtaining unit is further configured to determine the third sample coordinate as the first sample coordinate of the marker if the difference between the third sample coordinate of the marker and the preset sample coordinate is smaller than the preset difference.

In an embodiment, the obtaining unit is further configured to determine the third sample coordinate as a new preset sample coordinate if the difference between the third sample coordinate of the marker and the preset sample coordinate is not smaller than the preset difference, and return to segment a new geometry corresponding to the marker from the sample image based on the new preset sample coordinate, adjust the pixel values of the pixels in the new geometry that are smaller than the first preset pixel value to the second preset pixel value to obtain a second new geometry corresponding to the new geometry. The above steps are iterated until the difference between the third sample coordinate of the marker corresponding to a currently obtained second new geometry and the new preset sample coordinate is smaller than the preset difference. At this point, the third sample coordinate of the marker corresponding to the currently obtained second new geometry is taken as the first sample coordinate of the marker.

In an embodiment, the training module includes a determination unit and a training unit.

The determination unit is configured to determine target sample deformation information based on a first set of sample deformation information and a second set of sample deformation information.

The training unit is configured to train the initial deformation prediction model using the target sample deformation information and the sample reference coordinates of the markers to obtain the deformation prediction model.

In an embodiment, the image is an MR image, and the method is configured to correct the distortion in the image associated with the gradient nonlinearity.

In an embodiment, an apparatus for training a deformation prediction model is also provided, which includes a fourth determination module, an obtaining module, a registration module, a third determination module, and a training module.

The fourth determination module is configured to determine the initial deformation prediction model.

The obtaining module is configured to obtain the first sample coordinates of the markers in the calibration phantom based on the sample image of the calibration phantom.

The registration module is configured to register the first sample coordinates of the markers and the sample reference coordinates to determine second sample coordinates of the markers in the image coordinate system.

The third determination module is configured to determine sample deformation information of the markers based on the second sample coordinates and the first sample coordinates of the markers.

The training module is configured to train the initial deformation prediction model using the sample reference coordinates and the sample deformation information of the markers to obtain the deformation prediction model.

In the apparatus for correcting the image described above, each module can be implemented through software, hardware, or a combination thereof. These modules can be embedded in the processor of the computer device in hardware form, or stored in the memory of the computer device in software form, making it convenient for the processor to call and perform the corresponding operations of each module.

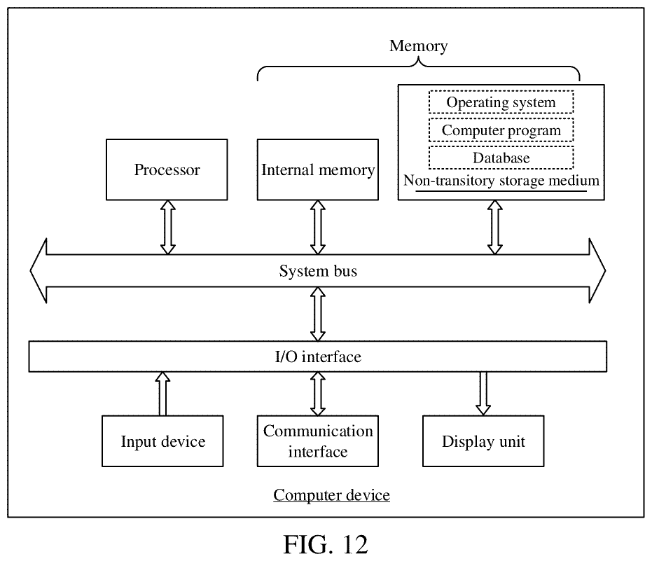

In an exemplary embodiment, a computer device is provided, which may be a terminal, with an internal structure diagram shown in FIG. 12. The computer device includes a processor, a memory, an input/output interface, a communication interface, a display unit, and an input device. The processor, memory, and input/output interface are connected through a system bus, and the communication interface, display unit, and input device are connected to the system bus via the input/output interface. The processor provides computational and control capabilities. The memory includes a non-transitory storage medium and an internal memory. The non-transitory storage medium stores the operating system and computer programs, while the internal memory provides an environment for the execution of these programs. The input/output interface facilitates information exchange between the processor and external devices. The communication interface is used for wired or wireless communication with external terminals, and wireless communication can be implemented through technologies such as WIFI, cellular networks, NFC (Near Field Communication), or other technologies. The computer program is executed by the processor to implement the method for correcting an image. The display unit displays a visual image that can be seen, which can be a display screen, a projection device, or a virtual reality imaging device. The display screen can be an LCD screen or an electronic ink display. The input device can be a touch layer covering the display screen, or buttons, trackballs, or touchpads on the computer device housing. Additionally, external devices like keyboards, touchpads, or mice can be used.

Those skilled in the art will appreciate that the structure shown in FIG. 12 is merely a block diagram of the part of the structure related to the solution of the present disclosure and does not constitute a limitation on the computer device to which the solution is applied. The specific computer device may include more or fewer components than those shown in the figure, may combine some components, or have a different component layout.

In an exemplary embodiment, a computer device is provided, including a memory and a processor. The memory stores a computer program. The processor, when executing the computer program, is configured to perform a method for correcting an image according to any of the above-described various embodiments.

In some embodiments, the processor, when executing the computer program, is configured to obtain deformation information of pixels in the image based on first coordinates of the pixels through a deformation prediction model, where the deformation information includes target deformation information caused by gradient nonlinearity of a gradient magnetic field, determine second coordinates corresponding to the first coordinates based on the target deformation information and the first coordinates, and correct the image based on pixel values corresponding to the second coordinates.

In an embodiment, the processor, when executing the computer program, is configured to obtain first sample coordinates of markers in a calibration phantom based on a sample image of the calibration phantom, register the first sample coordinates of the markers with sample reference coordinates to determine second sample coordinates of the markers in an image coordinate system, determine sample deformation information of the markers based on the second sample coordinates and the first sample coordinates, and train an initial deformation prediction model using the sample reference coordinates and the sample deformation information of the markers to obtain the deformation prediction model.

In an embodiment, the processor when executing the computer program, is further configured to segment geometries corresponding to the markers from the sample image based on the preset sample coordinates of the markers, adjust pixel values of pixels in each geometry that are smaller than a first preset pixel value to a second preset pixel value to obtain a first new geometry corresponding to the geometry, and obtain the first sample coordinate of each marker based on the pixel values of the pixels in the first new geometry corresponding to the geometry.

In an embodiment, the processor, when executing the computer program, is further configured to determine third sample coordinates of the markers corresponding to the first new geometries based on the pixel values of the pixels in the first new geometries, and obtain the first sample coordinates of the markers based on the third sample coordinates of the markers corresponding to the first new geometries and the preset sample coordinates.

In an embodiment, the processor, when executing the computer program, is further configured to take the third sample coordinate of the marker as the first sample coordinate of the marker if the difference between the third sample coordinate of the marker and the preset sample coordinate is smaller than a preset difference.

In an embodiment, the processor, when executing the computer program, is further configured to take the third sample coordinate as a new preset sample coordinate if the difference between the third sample coordinate of the marker and the preset sample coordinate is not smaller than the preset difference, and return to segment a new geometry corresponding to the marker from the sample image based on the new preset sample coordinate, adjust the pixel values of the pixels in the new geometry that are smaller than the first preset pixel value to the second preset pixel value to obtain a second new geometry corresponding to the new geometry. The above steps are iterated until the difference between the third sample coordinate of the marker corresponding to a currently obtained second new geometry and the new preset sample coordinate is smaller than the preset difference. At this point, the third sample coordinate of the marker corresponding to the currently obtained second new geometry is taken as the first sample coordinate of the marker.

In an embodiment, the processor, when executing the computer program, is further configured to determine target sample deformation information based on a first set of sample deformation information and a second set of sample deformation information, and train the initial deformation prediction model using the target sample deformation information and the sample reference coordinates of the markers to obtain the deformation prediction model.

In an embodiment, the image is an MR image, and the method is configured to correct a distortion in the image associated with the gradient nonlinearity of the gradient magnetic field.

In an embodiment, the processor, when executing the computer program, is further configured to determine the initial deformation prediction model, obtain the first sample coordinates of the markers in the calibration phantom based on the sample image of the calibration phantom, register the first sample coordinates of the markers with the sample reference coordinates to determine the second sample coordinates of the marker in the image coordinate system, determine the sample deformation information of the markers based on the second sample coordinates and the first sample coordinates of the markers, and train the initial deformation prediction model using the sample reference coordinates of the markers and the sample deformation information to obtain the deformation prediction model.

In an embodiment, a computer-readable storage medium is provided, which stores a computer program. The computer program, when executed by a processor, causes the processor to obtain deformation information of pixels in the image based on first coordinates of the pixels through a deformation prediction model, where the deformation information includes target deformation information caused by gradient nonlinearity of a gradient magnetic field, determine second coordinates corresponding to the first coordinates based on the target deformation information and the first coordinates, and correct the image based on pixel values corresponding to the second coordinates.

In an embodiment, the computer program, when executed by a processor, causes the processor to obtain first sample coordinates of markers in a calibration phantom based on a sample image of the calibration phantom, register the first sample coordinates of the markers with sample reference coordinates to determine second sample coordinates of the markers in an image coordinate system, determine sample deformation information of the markers based on the second sample coordinates and the first sample coordinates, and train an initial deformation prediction model using the sample reference coordinates and sample deformation information of the markers to obtain a deformation prediction model.

In an embodiment, the computer program, when executed by a processor, causes the processor to segment geometries corresponding to the markers from the sample image based on the preset sample coordinates of the markers, adjust pixel values of pixels in each geometry that are smaller than a first preset pixel value to a second preset pixel value to obtain a first new geometry corresponding to the geometry, and obtain the first sample coordinate of each marker based on the pixel values of the pixels in the first new geometry corresponding to the geometry.

In an embodiment, the computer program, when executed by a processor, causes the processor to determine third sample coordinates of the markers corresponding to the first new geometries based on the pixel values of the pixels in the first new geometries, and obtain the first sample coordinates of the markers based on the third sample coordinates of the markers corresponding to the first new geometries and the preset sample coordinates.

In an embodiment, the computer program, when executed by a processor, causes the processor to take the third sample coordinate of the marker as the first sample coordinate of the marker if the difference between the third sample coordinate of the marker and the preset sample coordinate is smaller than a preset difference.

In an embodiment, the computer program, when executed by a processor, causes the processor to take the third sample coordinate as a new preset sample coordinate if the difference between the third sample coordinate of the marker and the preset sample coordinate is not smaller than the preset difference, and return to segment a new geometry corresponding to the marker from the sample image based on the new preset sample coordinate, adjust the pixel values of the pixels in the new geometry that are smaller than the first preset pixel value to the second preset pixel value to obtain a second new geometry corresponding to the new geometry. The above steps are iterated until the difference between the third sample coordinate of the marker corresponding to a currently obtained second new geometry and the new preset sample coordinate is smaller than the preset difference. At this point, the third sample coordinate of the marker corresponding to the currently obtained second new geometry is taken as the first sample coordinate of the marker.

In an embodiment, the computer program, when executed by a processor, causes the processor to determine target sample deformation information based on a first set of sample deformation information and a second set of sample deformation information, and train the initial deformation prediction model using the target sample deformation information and the sample reference coordinates of the markers to obtain the deformation prediction model.

In an embodiment, the image is an MR image, and the method is configured to correct a distortion in the image associated with the gradient nonlinearity of the gradient magnetic field.

In an embodiment, the computer program, when executed by a processor, causes the processor to determine the initial deformation prediction model, obtain the first sample coordinates of the markers in the calibration phantom based on the sample image of the calibration phantom, register the first sample coordinates of the markers with the sample reference coordinates to determine the second sample coordinates of the marker in the image coordinate system, determine the sample deformation information of the markers based on the second sample coordinates and the first sample coordinates of the markers, and train the initial deformation prediction model using the sample reference coordinates of the markers and the sample deformation information to obtain the deformation prediction model.

In an embodiment, a computer program product is provided, which includes a computer program that, when executed by a processor, causes the processor to obtain deformation information of pixels in the image based on first coordinates of the pixels through a deformation prediction model, where the deformation information includes target deformation information caused by gradient nonlinearity of a gradient magnetic field, determine second coordinates corresponding to the first coordinates based on the target deformation information and the first coordinates, and correct the image based on pixel values corresponding to the second coordinates.

In an embodiment, the computer program, when executed by a processor, causes the processor to obtain first sample coordinates of markers in a calibration phantom based on a sample image of the calibration phantom, register the first sample coordinates of the markers with sample reference coordinates to determine second sample coordinates of the markers in an image coordinate system, determine sample deformation information of the markers based on the second sample coordinates and the first sample coordinates, and train an initial deformation prediction model using the sample reference coordinates and sample deformation information of the markers to obtain a deformation prediction model.

In an embodiment, the computer program, when executed by a processor, causes the processor to segment geometries corresponding to the markers from the sample image based on the preset sample coordinates of the markers, adjust pixel values of pixels in each geometry that are smaller than a first preset pixel value to a second preset pixel value to obtain a first new geometry corresponding to the geometry, and obtain the first sample coordinate of each marker based on the pixel values of the pixels in the first new geometry corresponding to the geometry.

In an embodiment, the computer program, when executed by a processor, causes the processor to determine third sample coordinates of the markers corresponding to the first new geometries based on the pixel values of the pixels in the first new geometries, and obtain the first sample coordinates of the markers based on the third sample coordinates of the markers corresponding to the first new geometries and the preset sample coordinates.

In an embodiment, the computer program, when executed by a processor, causes the processor to take the third sample coordinate of the marker as the first sample coordinate of the marker if the difference between the third sample coordinate of the marker and the preset sample coordinate is smaller than a preset difference.

In an embodiment, the computer program, when executed by a processor, causes the processor to take the third sample coordinate as a new preset sample coordinate if the difference between the third sample coordinate of the marker and the preset sample coordinate is not smaller than the preset difference, and return to segment a new geometry corresponding to the marker from the sample image based on the new preset sample coordinate, adjust the pixel values of the pixels in the new geometry that are smaller than the first preset pixel value to the second preset pixel value to obtain a second new geometry corresponding to the new geometry. The above steps are iterated until the difference between the third sample coordinate of the marker corresponding to a currently obtained second new geometry and the new preset sample coordinate is smaller than the preset difference. At this point, the third sample coordinate of the marker corresponding to the currently obtained second new geometry is taken as the first sample coordinate of the marker.

In an embodiment, the computer program, when executed by a processor, causes the processor to determine target sample deformation information based on a first set of sample deformation information and a second set of sample deformation information, and train the initial deformation prediction model using the target sample deformation information and the sample reference coordinates of the markers to obtain the deformation prediction model.

In an embodiment, the image is an MR image, and the method is configured to correct a distortion in the image associated with the gradient nonlinearity of the gradient magnetic field.

In an embodiment, the computer program, when executed by a processor, causes the processor to determine the initial deformation prediction model, obtain the first sample coordinates of the markers in the calibration phantom based on the sample image of the calibration phantom, register the first sample coordinates of the markers with the sample reference coordinates to determine the second sample coordinates of the marker in the image coordinate system, determine the sample deformation information of the markers based on the second sample coordinates and the first sample coordinates of the markers, and train the initial deformation prediction model using the sample reference coordinates of the markers and the sample deformation information to obtain the deformation prediction model.

It should be noted that the user information (including but not limited to user device information, user personal information, etc.) and data (including but not limited to data used for analysis, stored data, displayed data, etc.) involved in the present disclosure are all authorized by the user or authorized by the relevant parties, and the collection, use, and processing of the relevant data must comply with relevant regulations.

The ordinary technical personnel in this field can understand that the entire or part of the process in the implementation example method can be completed by instructing the relevant hardware through a computer program. The computer program can be stored in a non-transitory computer-readable storage medium. When executed, the program may include the process of the implementation example methods mentioned above. In the embodiments of the present disclosure, any reference to memory, database, or other medium can include at least one of non-transitory and volatile memories. Non-transitory memory may include read-only memory (ROM), tapes, floppy disks, flash memory, optical storage, high-density embedded non-transitory memory, resistive random access memory (ReRAM), magnetoresistive random access memory (MRAM), ferroelectric random access memory (FRAM), phase-change memory (PCM), graphene memory, and so on. Volatile memory may include random access memory (RAM) or external cache memory. As an example, RAM can take various forms, such as static random access memory (SRAM) or dynamic random access memory (DRAM), and so on.

The databases involved in the implementation examples provided by the present disclosure may include at least one of relational databases and non-relational databases. Non-relational databases may include distributed databases based on blockchain, but not limited to this. The processors involved in the implementation examples provided by the present disclosure may include general processors, central processing units (CPU), graphics processing units (GPU), digital signal processors (DSP), programmable logic devices, quantum computing-based data processing logic devices, and so on, without limitation.

The technical features of the above implementation examples can be combined in any way. To keep the description concise, not all possible combinations of the technical features in the above implementation examples are described. However, as long as there are no contradictions in these combinations, they should be considered within the scope described in this specification.

The above implementation examples only express a few of the embodiments of the present disclosure, which are described in more detail, but should not be understood as limiting the scope of the patent. It should be noted that for ordinary technical personnel in this field, several variations and improvements can be made without departing from the spirit of the present disclosure, and these fall within the protection scope of the present disclosure. Therefore, the protection scope of the present disclosure should be subject to the appended claims.

What is claimed is:

1. A method for correcting an image, comprising:
obtaining deformation information of pixels in the image based on first coordinates of the pixels through a deformation prediction model, where the deformation information comprises target deformation information caused by gradient nonlinearity of a gradient magnetic field;
determining second coordinates corresponding to the first coordinates based on the target deformation information and the first coordinates; and
correcting the image based on pixel values corresponding to the second coordinates.

2. The method according to claim 1, further comprising obtaining the deformation prediction model, wherein obtaining the deformation prediction model comprises:
obtaining first sample coordinates of markers in a calibration phantom based on a sample image of the calibration phantom;
registering the first sample coordinates of the markers with sample reference coordinates to determine second sample coordinates of the markers in an image coordinate system;
determining sample deformation information of the markers based on the second sample coordinates and the first sample coordinates of the markers; and
training an initial deformation prediction model using the sample reference coordinates and sample deformation information of the markers to obtain the deformation prediction model.

3. The method according to claim 2, wherein obtaining the first sample coordinates of the markers in the calibration phantom based on the sample image of the calibration phantom comprises:
segmenting geometries corresponding to the markers from the sample image based on preset sample coordinates of the markers;
adjusting pixel values of pixels in each geometry that are smaller than a first preset pixel value to a second preset pixel value to obtain a first new geometry corresponding to the geometry; and
obtaining the first sample coordinate of each marker based on pixel values of pixels in the first new geometry corresponding to the geometry.

4. The method according to claim 3, wherein the sample image is a three-dimensional sample image, and segmenting the geometries corresponding to the markers from the sample image based on the preset sample coordinates of the markers comprises:
determining a size of each marker based on a density of the marker, and segmenting the geometry corresponding to the marker from the sample image with a pixel of the preset sample coordinate as a center of the geometry.

5. The method according to claim 3, wherein obtaining the first sample coordinate of each marker based on the pixel values of the pixels in the first new geometry corresponding to the geometry comprises:
determining a third sample coordinate of the marker corresponding to the first new geometry based on the pixel values of the pixels in the first new geometry; and
obtaining the first sample coordinate of the marker based on the third sample coordinate of the marker corresponding to the first new geometry and the preset sample coordinate.

6. The method according to claim 5, wherein determining the third sample coordinate of the marker corresponding to the first new geometry based on the pixel values of the pixels in the first new geometry comprises:
summing products of the pixel values of the pixels and corresponding coordinates in the first new geometry to obtain a first sum result;
summing the pixel values of the pixels in the first new geometry to obtain a second sum result; and
taking a ratio of the first sum result to the second sum result as the third sample coordinate of the marker.

7. The method according to claim 5, wherein obtaining the first sample coordinate of the marker based on the third sample coordinate of the marker corresponding to the first new geometry and the preset sample coordinate comprises:
taking the third sample coordinate of the marker as the first sample coordinate of the marker if a difference between the third sample coordinate of the marker and the preset sample coordinate is smaller than a preset difference.

8. The method according to claim 5, wherein obtaining the first sample coordinate of the marker based on the third sample coordinate of the marker corresponding to the first new geometry and the preset sample coordinate comprises:
segmenting a geometry corresponding to the marker from the sample image based on the third preset sample coordinate if a difference between the third sample coordinate of the marker and the preset sample coordinate is not smaller than a preset difference;
adjusting pixel values of pixels in the geometry that are smaller than the first preset pixel value to the second preset pixel value to obtain a second new geometry; and
obtaining the first sample coordinate of the marker based on pixel values of pixels in the second new geometry.

9. The method according to claim 7, wherein the sample image comprises a first sample image and a second sample image with opposite polarities, the sample deformation information comprises a first set of sample deformation information corresponding to the first sample image and a second set of sample deformation information corresponding to the second sample image, and training the initial deformation prediction model using the sample reference coordinates and sample deformation information of the markers to obtain the deformation prediction model comprises:
determining the target sample deformation information based on the first set of sample deformation information and the second set of sample deformation information; and
training the initial deformation prediction model using the target sample deformation information and the sample reference coordinates of the markers to obtain the deformation prediction model.

10. The method according to claim 1, wherein the image is a magnetic resonance image, and the method is applied to correct a distortion in the image associated with the gradient nonlinearity of the gradient magnetic field.

11. The method according to claim 1, wherein correcting the image based on the pixel values corresponding to the second coordinates comprises:
assigning the pixel values corresponding to the second coordinates to the corresponding first coordinates, or adjusting the pixel values corresponding to the second coordinates and assigning the adjusted pixel values to the corresponding first coordinates.

12. A method for determining a deformation prediction model, comprising:
determining an initial deformation prediction model;
obtaining first sample coordinates of markers in the calibration phantom from a sample image of the calibration phantom;
registering the first sample coordinates of the markers and sample reference coordinates to determine second sample coordinates of the markers in an image coordinate system;
determining sample deformation information of the markers based on the second sample coordinates of the markers and the first sample coordinates; and
training the initial deformation prediction model using the sample reference coordinates of the markers and the sample deformation information to obtain the deformation prediction model.

13. A computer device, comprising a memory and a processor, wherein the memory stores a computer program, and the processor, when executing the computer program, is configured to perform a method for correcting an image, the method comprising:
obtaining deformation information of pixels in the image based on first coordinates of the pixels through a deformation prediction model, where the deformation information comprises target deformation information caused by gradient nonlinearity of a gradient magnetic field;
determining second coordinates corresponding to the first coordinates based on the target deformation information and the first coordinates; and
correcting the image based on pixel values corresponding to the second coordinates.

14. The computer device according to claim 13, wherein the method further comprises obtaining the deformation prediction model, and obtaining the deformation prediction model comprises:
obtaining first sample coordinates of markers in a calibration phantom based on a sample image of the calibration phantom;
registering the first sample coordinates of the markers with sample reference coordinates to determine second sample coordinates of the markers in an image coordinate system;
determining sample deformation information of the markers based on the second sample coordinates and the first sample coordinates of the markers; and
training an initial deformation prediction model using the sample reference coordinates and sample deformation information of the markers to obtain the deformation prediction model.

15. The computer device according to claim 14, wherein obtaining the first sample coordinates of the markers in the calibration phantom based on the sample image of the calibration phantom comprises:
segmenting geometries corresponding to the markers from the sample image based on preset sample coordinates of the markers;
adjusting pixel values of pixels in each geometry that are smaller than a first preset pixel value to a second preset pixel value to obtain a first new geometry corresponding to the geometry; and
obtaining the first sample coordinate of each marker based on pixel values of pixels in the first new geometry corresponding to the geometry.

16. The computer device according to claim 15, wherein obtaining the first sample coordinate of each marker based on the pixel values of the pixels in the first new geometry corresponding to the geometry comprises:
determining a third sample coordinate of the marker corresponding to the first new geometry based on the pixel values of the pixels in the first new geometry; and
obtaining the first sample coordinate of the marker based on the third sample coordinate of the marker corresponding to the first new geometry and the preset sample coordinate.

17. The computer device according to claim 16, wherein determining the third sample coordinate of the marker corresponding to the first new geometry based on the pixel values of the pixels in the first new geometry comprises:
summing products of the pixel values of the pixels and corresponding coordinates in the first new geometry to obtain a first sum result;
summing the pixel values of the pixels in the first new geometry to obtain a second sum result; and
taking a ratio of the first sum result to the second sum result as the third sample coordinate of the marker.

18. The computer device according to claim 16, wherein obtaining the first sample coordinate of the marker based on the third sample coordinate of the marker corresponding to the first new geometry and the preset sample coordinate comprises:
taking the third sample coordinate of the marker as the first sample coordinate of the marker if a difference between the third sample coordinate of the marker and the preset sample coordinate is smaller than a preset difference.

19. The computer device according to claim 16, wherein obtaining the first sample coordinate of the marker based on the third sample coordinate of the marker corresponding to the first new geometry and the preset sample coordinate comprises:
segmenting a geometry corresponding to the marker from the sample image based on the third preset sample coordinate if a difference between the third sample coordinate of the marker and the preset sample coordinate is not smaller than a preset difference;
adjusting pixel values of pixels in the geometry that are smaller than the first preset pixel value to the second preset pixel value to obtain a second new geometry; and
obtaining the first sample coordinate of the marker based on pixel values of pixels in the second new geometry.

20. The computer device according to claim 18, wherein the sample image comprises a first sample image and a second sample image with opposite polarities, the sample deformation information comprises a first set of sample deformation information corresponding to the first sample image and a second set of sample deformation information corresponding to the second sample image, and training the initial deformation prediction model using the sample reference coordinates and sample deformation information of the markers to obtain the deformation prediction model comprises:
determining the target sample deformation information based on the first set of sample deformation information and the second set of sample deformation information; and
training the initial deformation prediction model using the target sample deformation information and the sample reference coordinates of the markers to obtain the deformation prediction model.
